(19) United States
(12) Patent Application Publication
(10) Pub. No.: US 2024/0412275 A1
(43) Pub. Date: Dec. 12, 2024

(54) INFORMATION PROCESSING METHOD, INFORMATION PROCESSING DEVICE, AND NON-TRANSITORY COMPUTER READABLE RECORDING MEDIUM

(71) Applicant: Panasonic Intellectual Property Corporation of America, Torrance, CA (US)

(72) Inventors: Motoji OHMORI, Osaka (JP); Tatsumi Nagashima, Osaka (JP); Minami Naka, Tokyo (JP)

(21) Appl. No.: 18/812,070

(22) Filed: Aug. 22, 2024

Related U.S. Application Data
(63) Continuation of application No. PCT/JP2022/044035, filed on Nov. 29, 2022.

(30) Foreign Application Priority Data
Feb. 22, 2022 (JP) 2022-025920

(51) Int. Cl. G06Q 30/0601

(52) U.S. Cl. CPC G06Q 30/0635

(57) ABSTRACT

An information processing device performs: acquiring a user ID, desired time information associated with the user ID and indicating a desired time or a desired timeframe for receiving a commodity, and ordered commodity information associated with the user ID; determining, on the basis of the desired time information and the ordered commodity information, whether an ordered commodity indicated by the ordered commodity information is receivable at the desired time or in the desired timeframe; deciding a receipt time or a receipt timeframe for the ordered commodity when the ordered commodity is determined to be receivable at the desired time or in the desired timeframe; and outputting receipt time information indicating the receipt time or the receipt timeframe.

### FIELD OF INVENTION

The present disclosure relates to a technology of providing information about delivery of commodities at a store.

### BACKGROUND ART

Patent Literature 1 discloses a technology of allowing a user to receive, at a parking lot or place of a store, a commodity of the store ordered online in advance. Specifically, Patent Literature 1 discloses a technology of, upon detection of an arrival of a vehicle of a user at a parking place of a store, arranging a commodity ordered by the user in a kiosk, displaying an instruction of delivering the commodity from the kiosk to the vehicle on a display of the kiosk, and making a clerk deliver the commodity from the kiosk to the vehicle in accordance with the instruction.

However, the technology of Patent Literature 1 fails to determine whether a commodity is deliverable at a desired time or in a desired timeframe for receiving the commodity, and thus needs further improvement for a smooth delivery of the commodity to a user.
Patent Literature 1: US Patent Publication No. 10373226

### SUMMARY OF THE INVENTION

The present disclosure has been accomplished to solve the drawbacks described above, and has an object of providing a technology of achieving a smooth delivery of a commodity to a user.

An information processing method according to one aspect of the present disclosure is an information processing method for providing information about delivery of commodities at a store. The information processing method includes: by a computer, acquiring a user ID, desired time information associated with the user ID and indicating a desired time or a desired timeframe for receiving a commodity, and ordered commodity information associated with the user ID; determining, on the basis of the desired time information and the ordered commodity information, whether an ordered commodity indicated by the ordered commodity information is receivable at the desired time or in the desired timeframe; deciding a receipt time or a receipt timeframe for the ordered commodity when the ordered commodity is determined to be receivable at the desired time or in the desired timeframe; and outputting receipt time information indicating the receipt time or the receipt timeframe.

This disclosure attains a smooth delivery of a commodity to a user.

### BRIEF DESCRIPTION OF THE DRAWINGS

FIG. 1 is a block diagram showing an example of an overall configuration of an information processing system in a first embodiment of the present disclosure.

FIG. 2 is a table showing an example of a data configuration of an ordered commodity database.

FIG. 3 is a flowchart showing an example of a process by the information processing system in the first embodiment.

FIG. 4 is an illustration of an example of an input screen image of desired time information.

FIG. 5 is a flowchart showing details of determination in step S4 in FIG. 3.

FIG. 6 is an illustration of an example of a pickup route.

FIG. 7 is an illustration of an example of a display screen image of receipt time information.

FIG. 8 is an illustration of a display screen image of receipt time information in another example.

FIG. 9 is a flowchart showing another example of details of the determination in step S4 in FIG. 3.

FIG. 10 is a view showing an example of a data configuration of a schedule information database.

FIG. 11 is a flowchart showing details of determination in step S4 in FIG. 3 in a second embodiment.

FIG. 12 is a flowchart showing an example of a process by an information processing system in a third embodiment.

FIG. 13 is a flowchart showing details of determination in step S402 in FIG. 12.

FIG. 14 is a view showing an example of a data configuration of a schedule information database in the third embodiment.

FIG. 15 is a flowchart showing an example of a process by an information processing system in a case where a user arrives by or at a receipt time, or within a receipt timeframe in a fourth embodiment.

FIG. 16 is an illustration of a periphery of a store.

FIG. 17 is an illustration of an example of a display screen image displayed on a store terminal.

FIG. 18 is an illustration of an example of a display screen image showing details of arrival time information about a certain order selected by a clerk.

FIG. 19 is a flowchart showing an example of a process by the information processing system in a case where the user fails to arrive by or at the receipt time, or within the receipt timeframe in the fourth embodiment.

FIG. 20 is an illustration of an example of a display screen image displayed on a store terminal on receipt of receipt time change information.

FIG. 21 is a flowchart showing an example of sending a change request for requesting a change of the receipt time or the receipt timeframe by the user terminal in the fourth embodiment.

### DETAILED DESCRIPTION

### Knowledge Forming the Basis of the Present Disclosure

A service for delivering a commodity of a store ordered online in advance to a user in a parking place of the store has been studied. In this service, when the user parks a vehicle thereof in the parking place of the store, a clerk delivers the commodity from the store to a parking location. This allows the user to receive the commodity without entering the store.

The user may designate a desired time or a desired timeframe for receiving a commodity at a store when ordering the commodity online. The store deploys a clerk for a delivery of the commodity to the user at the designated desired time or in the designated desired timeframe.

In this regard, a failure of delivering the commodity to the user at the desired time or in the desired timeframe may occur depending on a content of the ordered commodity. For instance, the failure may occur in a case where it takes a long time to pick up a commodity due to, for example, a large number of commodities having been ordered, a heavy weight of a commodity, or other reason.

When such a failure occurs, the user having come to the store to receive the commodity may be dissatisfied with no receipt of the commodity at the desired time or in the desired timeframe.

Under the circumstances, the present inventors have obtained the knowledge that a smooth delivery of a commodity to a user is achievable on the basis of determination as to whether an ordered commodity is receivable at a desired time or in a desired timeframe in consideration of the content of the ordered commodity, and the present inventors thus have conceived of the present disclosure.

(1) An information processing method according to one aspect of the present disclosure is an information processing method for providing information about delivery of commodities at a store. The information processing method includes: by a computer, acquiring a user ID, desired time information associated with the user ID and indicating a desired time or a desired timeframe for receiving a commodity, and ordered commodity information associated with the user ID; determining, on the basis of the desired time information and the ordered commodity information, whether an ordered commodity indicated by the ordered commodity information is receivable at the desired time or in the desired timeframe; deciding a receipt time or a receipt timeframe for the ordered commodity when the ordered commodity is determined to be receivable at the desired time or in the desired timeframe; and outputting receipt time information indicating the receipt time or the receipt timeframe.

In this configuration, a receipt time or a receipt timeframe is decided when an ordered commodity is determined to be receivable at a desired time or in a desired timeframe on the basis of the desired time information and the ordered commodity information. This configuration thus attains a smooth delivery of the commodity to the user, while avoiding decision of the receipt time or the receipt timeframe when the ordered commodity is unreceivable at the desired receipt time or in the desired timeframe.

(2) In the information processing method according to (1) above, in the outputting, when the ordered commodity is determined to be unreceivable at the desired time or in the desired timeframe, a request for a change of the desired time or the desired timeframe may be output.

This configuration prevents a time or a timeframe which is unavailable for a delivery by the store from being decided as a receipt time or a receipt timeframe in spite of determination that the ordered commodity is unreceivable at the desired time or in the desired timeframe.

(3) The information notification method according to (1) or (2) above may further include acquiring a current time. In the determining, a picking-up period required to pick up the ordered commodity may be calculated on the basis of the ordered commodity information, and it may be determined on the basis of the current time and the picking-up period whether the ordered commodity is receivable at the desired time or in the desired timeframe.

This configuration enables accurate determination as to whether the ordered commodity is receivable at the desired time or in the desired timeframe in consideration of a current time and the picking-up period required to pick up the ordered commodity.

(4) The information processing method according to (3) above may further include acquiring crowdedness timeframe information indicating a crowdedness timeframe of the store. In the determining, it may be determined whether a pickup time obtained by adding the picking-up period with respect to the current time falls within the crowdedness timeframe, and, when the pickup time is determined not to fall within the crowdedness timeframe, it may be determined whether the ordered commodity is receivable at the desired time or in the desired timeframe on the basis of determination as to whether the pickup time is earlier than the desired time.

This configuration enables decision of the receipt time and the receipt timeframe for the ordered commodity in such a manner as to avoid a crowdedness timeframe of the store.

(5) In the information processing method according to (3) or (4) above, in the calculating of the picking-up period, the picking-up period may be calculated on the basis of the number of ordered commodities indicated by the ordered commodity information.

This configuration enables accurate calculation of the picking-up period by using the number of ordered commodities.

(6) The information processing method according to any one of (3) to (5) above may further include acquiring commodity location information indicating respective locations of the commodities at the store. In the calculating of the picking-up period, a location of the ordered commodity may be specified on the basis of the commodity location information and the ordered commodity information, and the picking-up period may be calculated on the basis of the location of the ordered commodity.

This configuration enables accurate calculation of the picking-up period by using the location of the ordered commodity.

(7) In the information processing method according to any one of (1) to (6) above, in the outputting, display information about a location of the ordered commodity and a route for picking up the ordered commodity may be output.

This configuration enables the clerk to easily pick up the commodity owing to displaying of the pickup route.

(8) The information processing method according to (3) above may further include: determining a clerk to pick up the ordered commodity; acquiring schedule information associated with a clerk ID of the clerk and indicating a scheduled picking-up period being a picking-up period having been scheduled for the clerk; calculating an available period for the clerk by subtracting the scheduled picking-up period from the desired timeframe; determining whether the picking-up period exceeds the available period; and determining that the ordered commodity is receivable at the desired time or in the desired timeframe when the picking-up period does not exceed the available period.

In this configuration, an available period for a clerk is calculated by subtracting a scheduled picking-up period from the desired timeframe, and the ordered commodity is determined to be receivable at the desired time or in the desired timeframe when the picking-up period does not exceed the available period. The configuration thus enables accurate determination in consideration of the scheduled picking-up period.

(9) The information processing method according to (8) above may further include determining whether the ordered commodity indicated by the ordered commodity information includes a specific commodity. The available period may be calculated when the ordered commodity includes the specific commodity.

This configuration enables execution of calculating an available period in the desired timeframe by subtracting the scheduled picking-up period when the ordered commodity includes a specific commodity, and determining whether the picking-up period exceeds the available period.

(10) The information processing method according to (3) above may further include: acquiring crowdedness timeframe information indicating a crowdedness timeframe of the store; determining a clerk to pick up the ordered commodity; acquiring a scheduled picking-up period being a picking-up period which is associated with a clerk ID of the clerk and has been scheduled; calculating an available period for the clerk by subtracting the crowdedness timeframe and the scheduled picking-up period from the desired timeframe; determining whether the picking-up period exceeds the available period; and determining that the ordered commodity is receivable at the desired time or in the desired timeframe when the picking-up period does not exceed the available period.

In this configuration, an available period for a clerk is calculated by subtracting the crowdedness timeframe and a scheduled picking-up period from the desired timeframe, and the ordered commodity is determined to be receivable at the desired time or in the desired timeframe when the picking-up period does not exceed the available period. The configuration thus enables accurate determination in consideration of the crowdedness timeframe and the scheduled picking-up period.

(11) The information processing method according to any one of (8) to (10) above may further include calculating an available period for another clerk when the picking-up period exceeds the available period, and determining whether the picking-up period exceeds the available period for the another clerk.

This configuration enables determination as to whether the ordered commodity is receivable at the desired time or in the desired timeframe in consideration of an available period for another clerk.

(12) The information processing method according to (11) above may further include outputting a change request for a change of the desired time or the desired timeframe when the picking-up period exceeds the available period for the another clerk.

This configuration prevents the desired time or the desired timeframe from being decided as a receipt time or a receipt timeframe when another clerk is unable to pick up the ordered commodity at the desired time or in the desired timeframe.

(13) The information processing method according to any one of (1) to (12) above may further include: acquiring location information about a user terminal carried by the user and traffic information about a traffic in a periphery of the store; estimating an arrival time of the user on the basis of the traffic information when the user terminal is located in the periphery of the store a predetermined period before the receipt time or the receipt timeframe; and outputting the arrival time.

In this configuration, an arrival time of the user estimated on the basis of traffic information is output when the user is located in the periphery of the store a predetermined period before the receipt time or the receipt timeframe, and thus, the configuration allows the store to prepare for a delivery of the ordered commodity to meet the arrival time.

(14) The information processing method according to (13) above may further include: acquiring schedule information associated with a clerk ID of a clerk of the store and indicating a scheduled picking-up period being a picking-up period having been scheduled for the clerk; calculating an available period for the clerk by subtracting the scheduled picking-up period from the desired timeframe; generating receipt time change information including an available delivery time for the ordered commodity on the basis of the available period when the user terminal is not located in the periphery of the store; and outputting the receipt time change information.

In this configuration, an available delivery time for the ordered commodity is presented in consideration of an available period for a clerk when the user is not located in the periphery of the store a predetermined period before the receipt time or the receipt timeframe, and thus, the configuration allows the user to set another desired time or another desired timeframe with reference to the available delivery time.

(15) An information processing device in another aspect of the disclosure is an information processing device that provides information about delivery of commodities at a store. The information processing device includes: an acquisition part that acquires a user ID, desired time information associated with the user ID and indicating a desired time or a desired timeframe for receiving a commodity, and ordered commodity information associated with the user ID; a determination part that determines, on the basis of the desired time information and the ordered commodity information, whether an ordered commodity indicated by the ordered commodity information is receivable at the desired time or in the desired timeframe; a decision part that decides a receipt time or a receipt timeframe for the ordered commodity when the ordered commodity is determined to be receivable at the desired time or in the desired time; and an output part that outputs receipt time information indicating the receipt time or the receipt timeframe.

This configuration makes it possible to provide an information processing device that enables a smooth delivery of an ordered commodity to a user.

(16) An information processing program in another aspect of the present disclosure is an information processing program for providing information about delivery of commodities at a store. The information processing program includes: causing a computer to execute: acquiring a user ID, desired time information associated with the user ID and indicating a desired time or a desired timeframe for receiving a commodity, and ordered commodity information associated with the user ID; determining, on the basis of the desired time information and the ordered commodity information, whether an ordered commodity indicated by the ordered commodity information is receivable at the desired time or in the desired timeframe; deciding a receipt time or a receipt timeframe for the ordered commodity when the ordered commodity is determined to be receivable at the desired time or in the desired timeframe; and outputting receipt time information indicating the receipt time or the receipt timeframe.

This configuration makes it possible to provide an information processing program for a smooth delivery of an ordered commodity to a user.

This disclosure can be realized as an information updating system caused to operate by the information processing program as well. Additionally, it goes without saying that the computer program is distributable as a non-transitory computer readable storage medium like a CD-ROM, or distributable via a communication network like the Internet.

Each of the embodiments which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

### First Embodiment

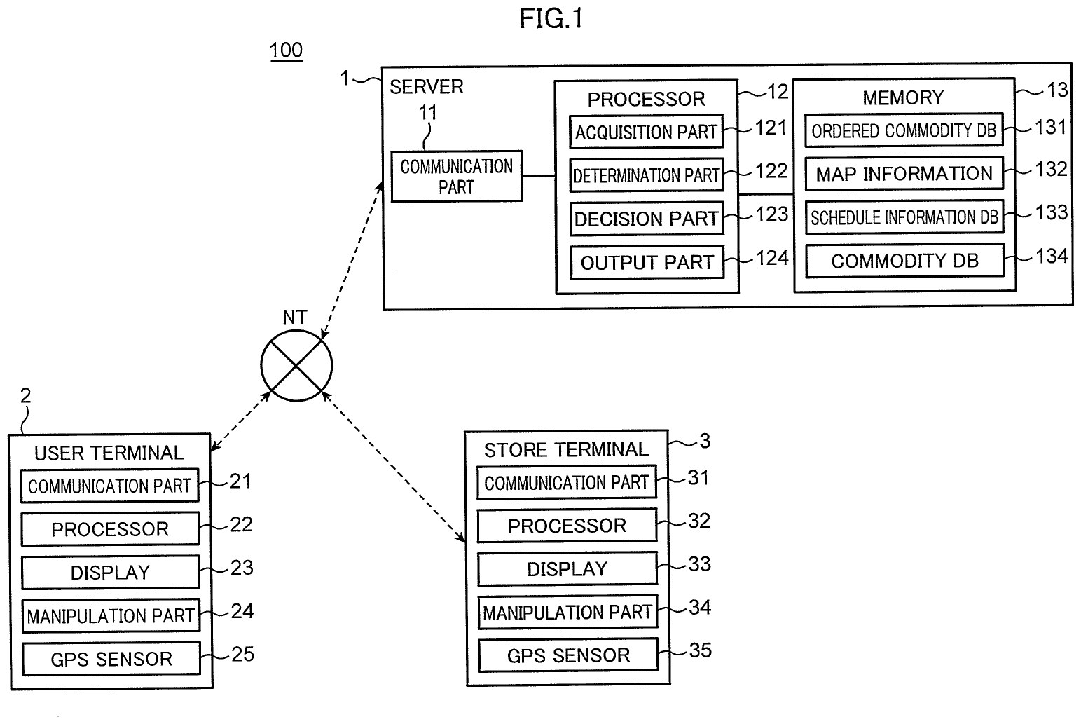

FIG. 1 is a block diagram showing an example of an overall configuration of an information processing system 100 in a first embodiment of the present disclosure. The information processing system 100 includes a server 1, a user terminal 2, and a store terminal 3. The server 1, the user terminal 2, and the store terminal 3 are communicably connected to one another via a network NT. The network NT includes, for example, a wide area network having the internet and a mobile phone communication network.

The server 1 includes, for example, a cloud server including a computer.

The store means a store where a user having purchased a commodity online receives the commodity. The administrative region of the store includes a building of the store and a parking place adjacent to the building. A plurality of commodities is arrayed in the building of the store. The building of the store further includes a repository that stores commodities.

The user terminal 2 is, for example, a mobile information terminal or personal digital assistant carried by the user. The mobile information terminal includes, for example, a smartphone or a tablet computer. The user terminal 2 may be formed of an in-vehicle terminal provided in the vehicle (not shown) which the user drives. The in-vehicle terminal is, for example, a car navigation system.

The store terminal 3 is, for example, a mobile information terminal carried by a clerk of the store.

Next, the configuration of the server 1 will be described in detail.

The server 1 includes a communication part 11, a processor 12, and a memory 13. The communication part 11 includes, for example, a communication circuit connecting the server 1 to the network NT. The communication part 11 receives a user ID and desired time information associated with the user ID from the user terminal 2. The user ID is an identifier of the user. The desired time information includes at least one of a desired time and a desired timeframe when the user desires to receive an ordered commodity at a store. The communication part 11 sends, to the user terminal 2, output information including receipt time information indicating a receipt time or a receipt timeframe for receiving the ordered commodity.

The processor 12 includes, for example, a CPU. The processor 12 has an acquisition part 121, a determination part 122, a decision part 123, and an output part 124. Each of the acquisition part 121 to the output part 124 comes into effect when the CPU executes an information processing program. Each of the acquisition part 121 to the output part 124 may be formed of a dedicated electric circuit, such as an ASIC.

The acquisition part 121 acquires a user ID, desired time information associated with the user ID and indicating a desired time or a desired timeframe for receiving a commodity, and ordered commodity information associated with the user ID. The user ID and the desired time information are sent from the user terminal 2. The ordered commodity information is acquired from an ordered commodity database 131.

The determination part 122 determines, on the basis of the desired time information and the ordered commodity information, whether an ordered commodity indicated by the ordered commodity information is receivable at the desired time or in the desired timeframe. Here, the determination part 122 calculates, on the basis of the ordered commodity information acquired by the acquisition part 121, a picking-up period required to pick up the ordered commodity, and determines whether the ordered commodity is receivable at the desired time or in the desired timeframe on the basis of a current time and the picking-up period.

The decision part 123 decides a receipt time or a receipt timeframe for the ordered commodity when the determination part 122 determines that the ordered commodity is receivable at the desired time or in the desired timeframe indicated by the desired time information.

The output part 124 outputs output information including receipt time information indicating the receipt time or the receipt timeframe. For instance, the output part 124 sends output information including the receipt time information to the user terminal 2 by using the communication part 11.

By contrast, when the determination part 122 determines that the ordered commodity is unreceivable at the desired time or in the desired timeframe, the output part 124 outputs output information including a change request for a change of the desired time or the desired timeframe. For instance, the output part 124 sends the output information including the change request to the user terminal 2 by using the communication part 11.

The memory 13 includes a non-volatile storage device. The memory 13 stores the ordered commodity database 131, map information 132, a schedule information database 133, and a commodity database 134.

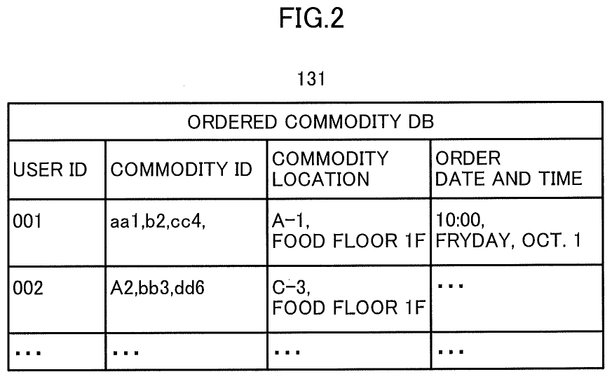

FIG. 2 is a table showing an example of a data configuration of the ordered commodity database 131. The ordered commodity database 131 includes a user ID field, a commodity ID field, a commodity location field, an order date and time field, and stores relevant information in the fields in association with one another. In the ordered commodity database 131, one record is associated with one order. The information indicating the one order represents ordered commodity information.

A user ID is an identifier of the user having ordered the commodity. The user ID may include, for example, a name or a symbol string registered in advance.

A commodity ID is an identifier of the commodity ordered by the user. The order associated with the record in the first row shows three commodities ordered by the user. The record hence has registration of commodity IDs “aa1”, “b2”, and “cc4” of these commodities.

A commodity location is a location of a commodity in a store. For instance, the record in the first row has registration that the commodity having the commodity ID “aa1” is located in “A-1 on Floor 1F”. Here, the term “A-1 on Floor F1” means that the associated commodity is located in the area A-1 on the first floor of the store. The store is divided into a plurality of areas per floor in advance and each of the areas is provided with an area number. Therefore, the symbol “A-1” denotes a relevant area number. This is just an example, and a coordinate defined in map information 132 to be described later and indicating a location of a commodity may indicate the commodity location.

An order date and time is a date and time of an order made by the user for a commodity. For instance, the order date and time in the first row indicates 10:00 on Friday on October 1^{st}.

Such an order as registered in the ordered commodity database 131 is made online by a user on the Internet. The user uses a user terminal 2 thereof to make an access to an order site of a relevant store and conducts a manipulation for ordering a desired commodity. In this manner, order information including: the user ID; the commodity ID; and the order date and time is sent to the server 1. The server 1 having received the order information creates a new record in the ordered commodity database 131, and registers, in the new record, the user ID, the commodity ID, and the order date and time included in the order information. The commodity location is specified with reference to the commodity database 134.

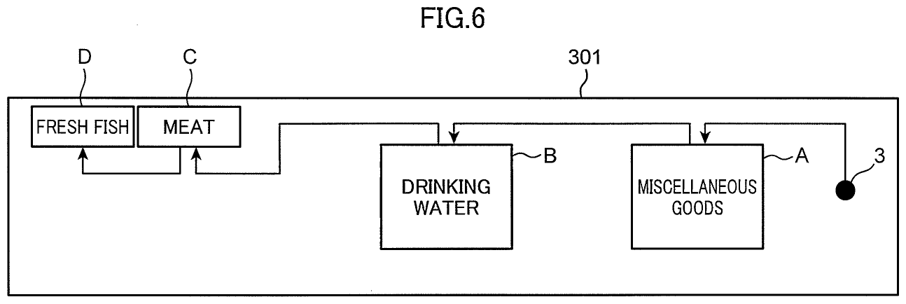

Referring back to FIG. 1, the map information 132 is information obtained by, for example, mapping a layout of the store as shown in FIG. 6 on a two-dimensional or three-dimensional coordinate space defined by an X-axis and a Y-axis.

The schedule information database 133 has registration of a schedule of a clerk and will be described in detail later.

The commodity database 134 stores information about each of the commodities in the store, and has registration of a commodity ID, an attribute of the commodity, and a location of the commodity in the store in association with one another for each commodity. The attribute of the commodity indicates whether the commodity is a specific commodity or not. The specific commodity includes a commodity which requires a quick delivery to a user having come to receive the ordered commodity. Examples of the specific commodity include a fresh food and a frozen food.

Heretofore, the configuration of the server 1 is described. Subsequently, the user terminal 2 will be described. The user terminal 2 includes a communication part 21, a processor 22, a display 23, a manipulation part 24, and a GPS sensor 25. The communication part 21 includes a communication circuit connecting the user terminal 2 to the network NT. The processor 22 includes, for example, a CPU, and controls the user terminal 2. The display 23 includes, for example, a liquid crystal panel and displays various images. The manipulation part 24 includes, for example, a touch screen and a physical button to receive a manipulation from a user. The GPS sensor 25 detects a location of the user terminal 2.

Next, the store terminal 3 will be described. The store terminal 3 includes a communication part 31, a processor 32, a display 33, a manipulation part 34, and a GPS sensor 35. The communication part 31 includes a communication circuit connecting the store terminal 3 to the network NT. The processor 32 includes, for example, a CPU, and controls the store terminal 3. The display 33 includes, for example, a liquid crystal panel and displays various images. The manipulation part 34 includes, for example, a touch screen and a physical button to receive a manipulation from a clerk. The GPS sensor 35 detects a location of the store terminal 3.

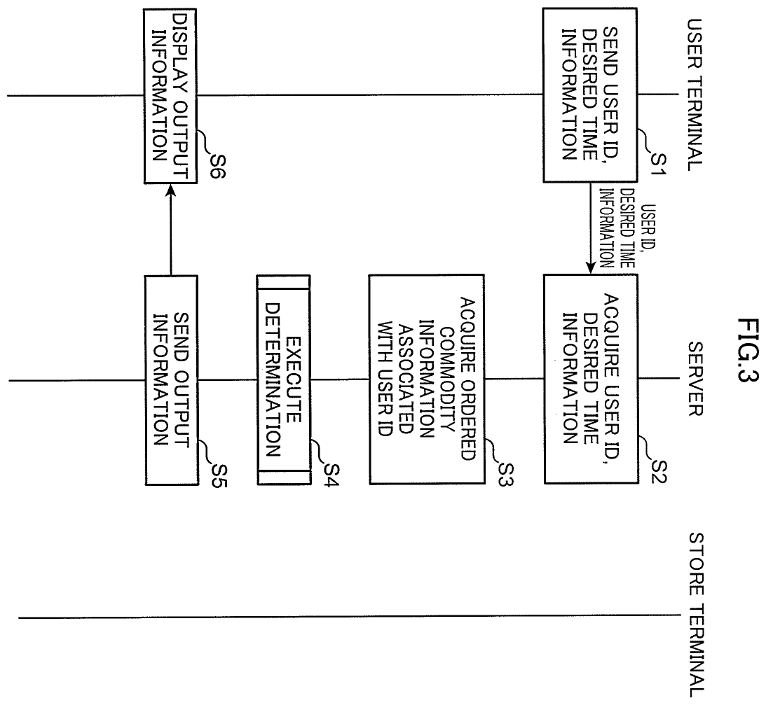

Hereinafter, a process by the information processing system 100 will be described. FIG. 3 is a flowchart showing a first example of the process by the information processing system 100 in the first embodiment. It is noted here that a user orders a commodity on an online site and the ordered commodity database 131 has registration of ordered commodity information indicating the ordered commodity prior to a start of the process in the flowchart.

### Step S1

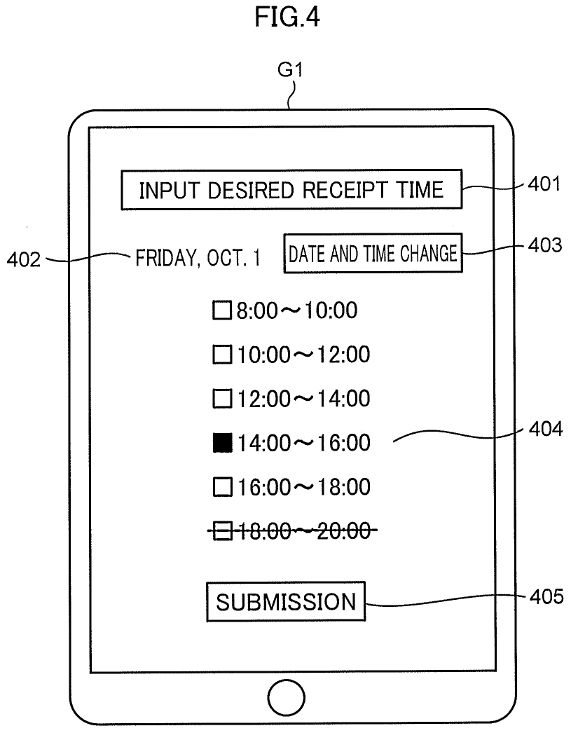

The user terminal 2 sends, to the server 1, desired time information input by the user in association with a user ID. FIG. 4 is an illustration of an example of a display screen image G1 of the desired time information. The display screen image G1 is displayed on the user terminal 2 for allowing the user to input the desired time information.

The display screen image G1 includes a message section 401, a date and time display section 402, a date and time change button 403, a selection section 404, and a submission button 405. The message section 401 shows a message encouraging the user to input a desired receipt time.

The date and time display section 402 shows a desired date for receiving an ordered commodity. The date and time display section 402 shows, at a default setting, a date of the day on which the user ordered the commodity. Here, the date and time display section 402 shows “Friday, October 1^{st}” for the order made by the user for the commodity on Friday on October 1^{st}.

The date and time change button 403 is a button to be touched by the user when the user designates a date for receiving the ordered commodity. The user terminal 2 displays a date selection screen image (not shown) in response to the touching of the date and time change button 403. The user inputs a desired date for receiving the ordered commodity into the date selection screen image.

The selection section 404 receives an input by the user concerning a desired timeframe for receiving the ordered commodity on the date displayed in the date and time display section 402. In this example, the selection section 404 includes six timeframes obtained by dividing opening hours from an opening time to a closing time of the store by two hours. The user selects one desired timeframe for the receipt from the timeframes. The user selects the one desired timeframe by touching a row showing the timeframe. In this example, the timeframe from 14:00 to 16:00 is selected by the user. A checkbox allotted to the row showing the timeframe in the display section is displayed in a different color. Besides, the row of the timeframe from 18:00 to 20:00 in the display section is stricken through to show that the timeframe is unavailable for a delivery of the commodity by the store due to some reasons of the store. Examples of some reasons of the store include a reason that clerks are fully reserved for deliveries of ordered commodities to other users, and thus, no clerk is available for a new delivery reservation.

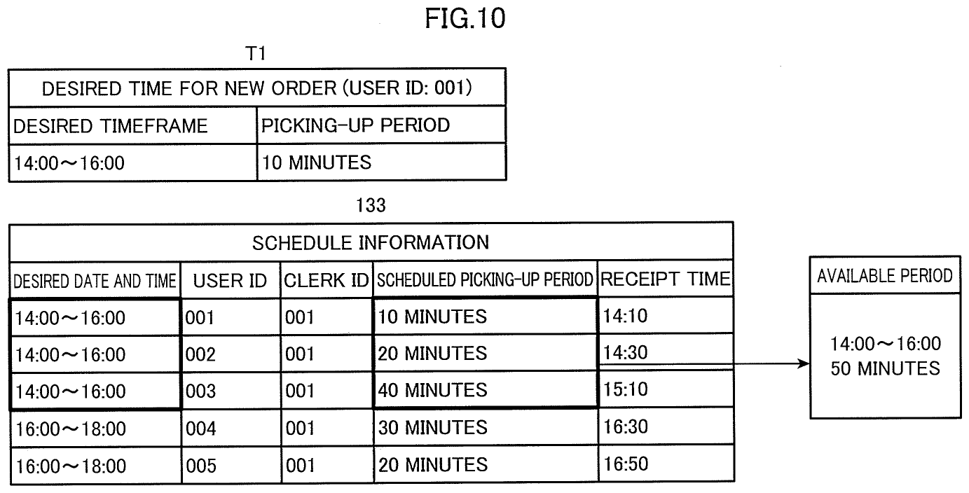

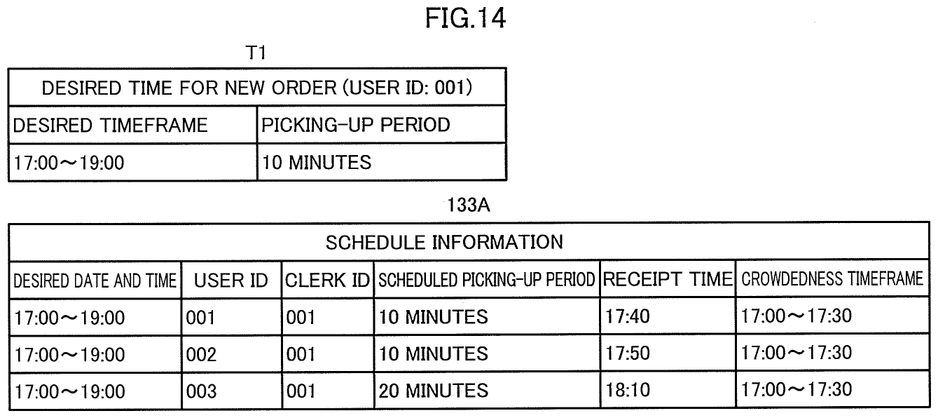

For instance, the server 1 determines, as an unavailable picking-up timeframe, a timeframe during which all the clerks have been already scheduled for their picking-up operations with reference to the schedule information database 133 shown in FIG. 10. When the user terminal 2 displays a display screen image G2, the server 1 may reflect the unavailable picking-up timeframe on the display screen image G1 by notifying the user terminal 2 of the unavailable picking-up timeframe. The server 1 may specify, as the unavailable picking-up timeframe, the timeframe during which all the clerks have been already scheduled for their picking-up operations and a crowdedness timeframe of the store with reference to a schedule information database 133A shown in FIG. 14

The submission button 405 is a button to be touched by the user to confirm selection of a desired timeframe. The user terminal 2 sends desired time information including the desired timeframe selected in the selection section 404 to the server 1 in association with the user ID in response to the touching of the submission button 405.

### Step S2

The acquisition part 121 of the server 1 acquires the user ID and the desired time information sent from the user terminal 2.

### Step S3

The acquisition part 121 of the server 1 acquires, from the ordered commodity database 131, ordered commodity information associated with the user ID acquired in step S2. Referring to FIG. 2, for instance, when desired time information concerning the user ID “001” is acquired in step S2, the acquisition part 121 acquires ordered commodity information in the first row. In a case where the ordered commodity database 131 has registration of a plurality of pieces of ordered commodity information for a certain user, the acquisition part 121 may acquire the latest ordered commodity information from the ordered commodity database 131.

### Step S4

The server 1 executes, on the basis of the ordered commodity information acquired in step S3 and the desired time information acquired in step S2, determination as to whether the ordered commodity is receivable by the user in the desired timeframe indicated by the desired time information. The determination will be described in detail later.

### Step S5

The output part 124 of the server 1 generates output information on the basis of a determination result of the determination. Specifically, the output part 124 sends output information including receipt time information to the user terminal 2 when the receipt time information is generated in step S4, and sends output information including a change request to the user terminal 2 when the change request is generated in step S4.

### Step S6

The user terminal 2 displays the output information.

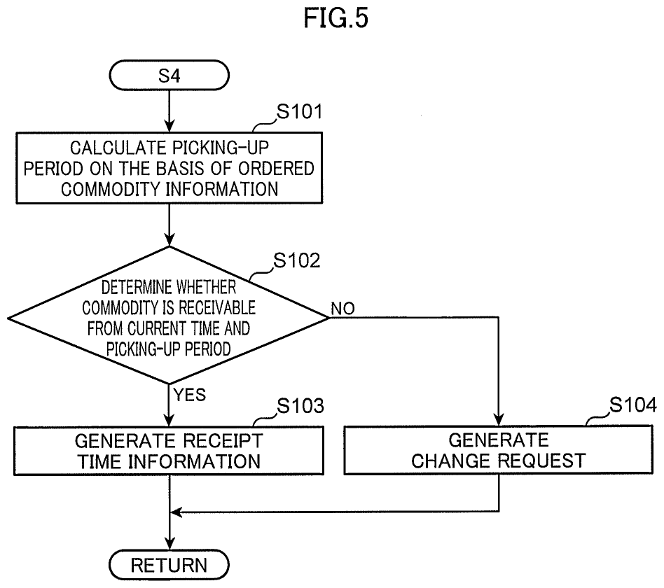

FIG. 5 is a flowchart showing details of the determination in step S4 in FIG. 3.

### Step S101

The determination part 122 calculates a picking-up period on the basis of the ordered commodity information acquired in step S3. The picking-up period represents a period required to pick up an ordered commodity by a clerk.

For instance, the picking-up period is calculated by using the ways (1) and (2) to be described below.

### Way (1)

The determination part 122 calculates a picking-up period on the basis of the number of ordered commodities indicated by ordered commodity information. For instance, the determination part 122 calculates a picking-up period with reference to a picking-up period table associating the number of ordered commodities with a reference picking-up period calculated in advance in connection with the number of ordered commodities. The picking-up period table stores a reference picking-up period in connection with the number of ordered commodities, e.g., a reference picking-up period of ten minutes for the number of ordered commodities from 1 to 10, a reference picking-up period of twenty minutes for the number of ordered commodities from 11 to 20, and a reference picking-up period of thirty minutes for the number of ordered commodities from 21 to 30. For instance, in a case of three ordered commodities, the picking-up period needs ten minutes. The reference picking-up period can have an average value of actual picking-up periods required by a clerk.

### Way (2)

The determination part 122 calculates a picking-up period on the basis of a location of an ordered commodity. More details will be described below. The determination part 122 may create a pickup route for picking up all the ordered commodities by a clerk carrying the store terminal 3 on the basis of respective locations of all the ordered commodities shown in the ordered commodity information acquired in step S3 and a location of the store terminal 3, and calculate a picking-up period by dividing a distance of the pickup route by an average walking speed of the clerk.

FIG. 6 is an illustration of an example of the pickup route. In the example in FIG. 6, the ordered commodities include a fresh fish, a meat, drinking water, and a piece of miscellaneous goods. First, the determination part 122 specifies respective commodity locations of the ordered commodities from the ordered commodity information acquired in step S3. Here, a miscellaneous goods section A, a drinking water section B, a meat section C, and a fresh fish section D are specified as the commodity locations. Subsequently, the determination part 122 specifies a coordinate indicating each of the specified commodity locations with reference to the map information 132. Here, a coordinate of each of the miscellaneous goods section A, the drinking water section B, the meat section C, and the fresh fish section D is specified. Next, the determination part 122 acquires location information indicating the location of the store terminal 3 from the store terminal 3 and specifies a coordinate of the store terminal 3 in the store 301 from the acquired location information.

The determination part 122 then creates the pickup route by arranging labels for the locations of the ordered commodities in ascending order of distance of the locations from the store terminal 3 by using the specified coordinate of each ordered commodity and the specified coordinate of the store terminal 3. Here, a distance from the store terminal 3 is shorter in order of the sections A, B, C, and D, and thus, a route of “A, B, C, and D” in this order is created as the pickup route. Subsequently, the determination part 122 calculates a distance between locations of ordered commodities by using the coordinates of the locations of the ordered commodities constituting the created pickup route. For instance, a distance between “A and B”, a distance between “B and C”, and a distance between “C and D” are calculated. The determination part 122 then calculates, as the distance of the pickup route, a total value of the calculated distances between the respective locations of the ordered commodities. For instance, a total value of the distance between “A and B”, the distance between “B and C”, and the distance between “C and D” is calculated as the distance of the pickup route. A distance from the location of the store terminal 3 to the location, i.e., the miscellaneous goods section A, of the first ordered commodity may be added to the distance of the pickup route.

When the ordered commodities are located over a plurality of floors, the determination part 122 may add a predetermined period (e.g., five minutes) to the picking-up period. In a case where an ordered commodity “A” is located on the first floor, an ordered commodity “B” is located on the second floor, and an ordered commodity “C” is located on the third floor in the example of the pickup route, it is necessary to move between floors twice. The determination part 122 thus may add a period of ten minutes obtained by multiplying a predetermined period of five minutes by the number of movements between floors, i.e., twice, to the picking-up period.

When an ordered commodity needs wrapping, the determination part 122 may add a predetermined period (e.g., five minutes) to the picking-up period. When at least one of the ordered commodities “A”, “B”, “C”, and “D” needs wrapping in the example of the pickup route, the determination part 122 may add the predetermined period (five minutes) to the picking-up period. In this case, the determination part 122 may increase the predetermined period as the number of ordered commodities which need wrapping increases. The attribute information may include information indicating whether the wrapping is necessary or unnecessary to determine the need of wrapping.

The server 1 may generate display information for displaying the pickup route shown in FIG. 6 and send the generated display information to the store terminal 3. In this case, as shown in FIG. 6, the store terminal 3 may display, on the display 33, a display screen image showing a pickup route superimposed and displayed on the map image of the store. An image of an arrow indicating the pickup route shows a line denoting a route connecting predefined selling sections to each other.

### Step S102

The determination part 122 determines, from a current time and the picking-up period calculated in step S101, whether an ordered commodity is receivable by the user in a desired timeframe. The determination part 122 calculates a pickup time by adding the picking-up period with respect to the current time. The determination part 122 may determine that the ordered commodity is receivable when the pickup time falls within the desired timeframe, and may determine that the ordered commodity is unreceivable when the pickup time is outside the desired timeframe. In a case where the desired time information includes a desired time, the determination part 122 may determine that the ordered commodity is receivable when the pickup time is earlier than the desired time, and may determine that the ordered commodity is unreceivable when the pickup time is later than the desired time.

The process proceeds to step S103 when the ordered commodity is determined to be receivable (YES in step S102), and the process proceeds to step S104 when the ordered commodity is determined to be unreceivable (NO in step S102).

For example, the picking-up period indicates thirty minutes, the current time indicates 15:50, and the desired timeframe indicates 16:00 to 17:00. The time 16:20 is earlier than the finish time 17:00 of the desired timeframe, and thus, it is determined to be “YES” in step S102.

### Step S103

The decision part 123 decides the pickup time as a receipt time and generates receipt time information indicating the receipt time. A receipt timeframe may be decided in place of the receipt time. In this case, the decision part 123 may decide, as the receipt timeframe, a predetermined period from the receipt time serving as a start time. The predetermined period may be defined on hourly basis, e.g., one hour and two hours, or may be defined on minute basis, e.g., five minutes, ten minutes, and thirty minutes. In a case where the desired time information includes a desired time, the decision part 123 may decide the desired time as the receipt time.

### Step S104

The decision part 123 generates a change request for a change of the desired timeframe. The change request includes, for example, the display screen image G1 shown in FIG. 4. In this case, the display screen image G1 may show an undeliverable timeframe which is stricken through. This allows the user to select a desired timeframe from among deliverable timeframes of the store.

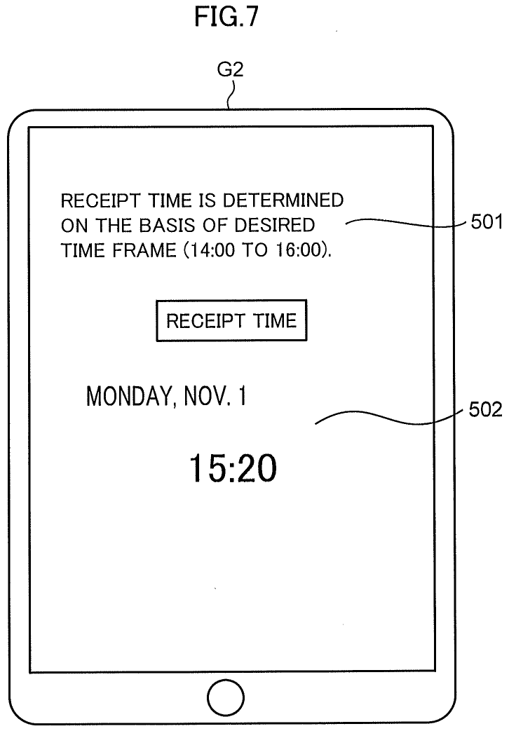

FIG. 7 is an illustration of an example of the display screen image G2 of the receipt time information. The display screen image G2 includes a message section 501 and a receipt time section 502. The message section 501 shows a message saying that a receipt time is decided on the basis of the desired timeframe (14:00 to 16:00) selected by the user on the display screen image G1.

The receipt time section 502 shows the receipt time. Here, the section shows the time 15:20 on Monday on November 1^{st} as the receipt time. This allows the user to easily confirm the receipt time.

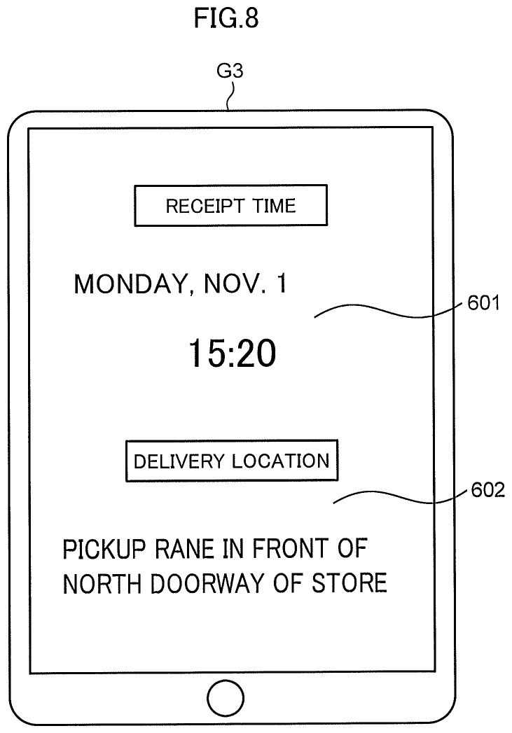

FIG. 8 is an illustration of a display screen image G3 of receipt time information in another example. The display screen image G3 includes a receipt time section 601 and a delivery location section 602. The receipt time section 601 is equivalent to the receipt time section 502 on the display screen image G2. The delivery location section 602 shows a delivery location for an ordered commodity. Here, the section shows a pickup lane in front of a north doorway of a store as the delivery location. The delivery location is determined in advance. This allows the user to easily confirm the receipt time and further easily confirm a specific location where the ordered commodity is receivable in an administrative region of the store.

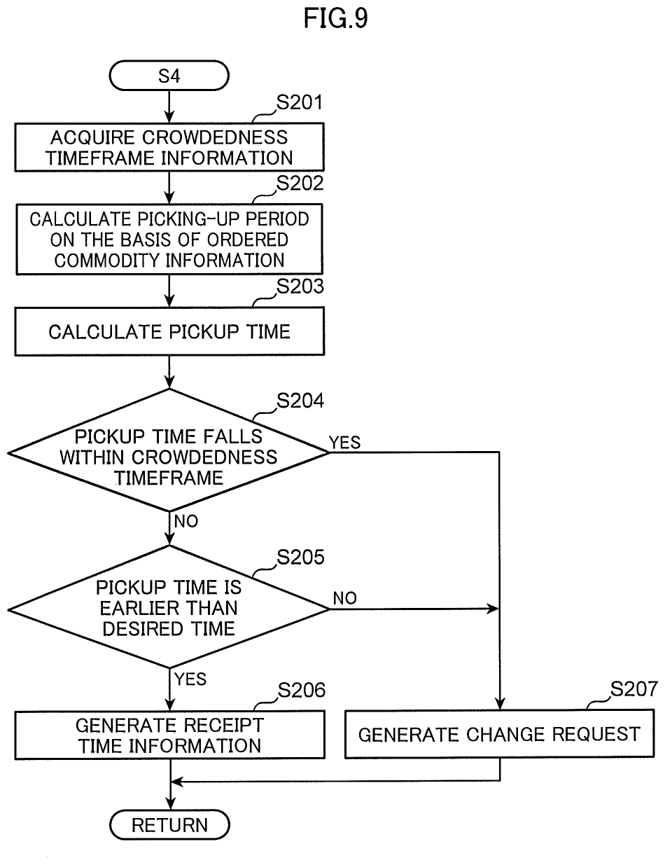

FIG. 9 is a flowchart showing another example of details of determination in step S4 in FIG. 3. This example differs from the example in FIG. 5 in that a receipt time is decided in consideration of a crowdedness timeframe of the store.

### Step S201

The acquisition part 121 acquires crowdedness timeframe information indicating a crowdedness timeframe of the store. The crowdedness timeframe indicates a timeframe during which many customers visit and enter the store and the store is crowded. The crowdedness timeframe information is stored in the memory 13 in advance. A timeframe estimated in advance is used as the crowdedness timeframe. The server 1 estimates the timeframe on the basis of, for example, data of a cash register or other register in past in the store, people-flow data analyzed from images captured by a camera provided in the store, and location information acquired from smartphones carried by customers.

The server 1 may calculate a crowdedness timeframe by collecting periods each from a time of input of treatment unavailable information indicating treatment unavailability of the clerk for a picking-up operation into the store terminal 3 to a time of input of treatment available information indicating treatment availability.

### Step S202

This step is the same as step S101 in FIG. 5.

### Step S203

The determination part 122 calculates a pickup time in consideration of a picking-up period calculated in step S202 with respect to a current time.

### Step S204

The determination part 122 determines whether the pickup time calculated in step S203 falls within the crowdedness timeframe indicated by the crowdedness timeframe information. The process proceeds to step S205 when the pickup time does not fall within the crowdedness timeframe (NO in step S204), and the process proceeds to step S207 when the pickup time falls within the crowdedness timeframe (YES in step S204).

### Step S205

The determination part 122 determines whether the pickup time is earlier than the desired time. The process proceeds to step S206 when the pickup time is earlier than the desired time (YES in step S205), and the process proceeds to step S207 when the pickup time is later than the desired time (NO in step S205). The determination part 122 may compare the pickup time with the desired timeframe. In this case, the determination part 122 may determine “YES” in step S205 when the pickup time is earlier than a finish time of the desired timeframe and may determine “NO” in step S205 when the pickup time is later than the finish time of the desired timeframe.

### Step S206

This step is the same as step S103 in FIG. 5.

### Step S207

This step is the same as step S104 in FIG. 5.

Conclusively, in the first embodiment, a receipt time or a receipt timeframe is decided when an ordered commodity is determined to be receivable at a desired time or in a desired timeframe on the basis of desired time information and ordered commodity information. The embodiment thus attains a smooth delivery of a commodity to a user while avoiding decision of the receipt time or the receipt timeframe when the ordered commodity is unreceivable at the desired receipt time or in the desired timeframe.

### Second Embodiment

A second embodiment is aimed at deciding a receipt time or a receipt timeframe in consideration of schedule information about a clerk. In the embodiment, constituent elements which are the same as those in the first embodiment are given the same reference numerals and signs, and thus, description therefor will be omitted. Further, an overall configuration will be described with reference to FIG. 1 in this embodiment.

Referring to FIG. 1, a determination part 122 determines one clerk to be a candidate for picking up an ordered commodity among a plurality of clerks of a store.

An acquisition part 121 acquires schedule information associated with a clerk ID of the clerk determined by the determination part 122. Here, the schedule information indicates a scheduled picking-up period being a picking-up period having been scheduled for the clerk.

The determination part 122 calculates an available period for the clerk by subtracting the scheduled picking-up period from a desired timeframe. The determination part 122 determines whether a picking-up period required for a new order exceeds the available period. The determination part 122 determines that the ordered commodity is receivable at a desired time or in a desired timeframe when the picking-up period required for the new order does not exceed the available period.

The acquisition part 121 may execute the acquisition, and the determination part 122 may execute the calculation and determination when the ordered commodity includes a specific commodity as described above.

FIG. 10 is a view showing an example of a data configuration of a schedule information database 133. The schedule information database 133 includes a desired date and time field, a user ID field, a clerk ID field, a scheduled picking-up period field, and a receipt time field, and stores relevant information in the fields. In the schedule information database 133, one record is associated with one piece of schedule information. The one piece of schedule information is associated with one picking-up operation. FIG. 10 shows a schedule information database of a clerk having the clerk ID “001”. The schedule information database 133 is created per clerk.

A desired date and time represents a desired timeframe which the user inputs through the display screen image G1. The user ID is an identifier of the user. The clerk ID is an identifier of the clerk. FIG. 10 shows schedule information about the clerk having the clerk ID “001”, and thus, all the clerk fields have registration of “001”. The scheduled picking-up period is a picking-up period calculated on the basis of ordered commodity information and having been scheduled for a picking-up operation. The receipt time represents a receipt time having been scheduled. For instance, the record in the first row shows a scheduled picking-up operation of delivering an ordered commodity to the user having the user ID “001” by the clerk having the clerk ID “001” at the receipt time “14:10”.

An upper table in FIG. 10 shows a desired timeframe and a picking-up period for a new order T1 to be treated. This example shows the desired timeframe “14:00 to 16:00” of the user having the user ID “001” and a picking-up period of “10 minutes”.

Next, a process by an information processing system 100 in the second embodiment will be described. The process has the same main routine as that in FIG. 3. The difference from the first embodiment is seen in determination in step S4 in FIG. 3.

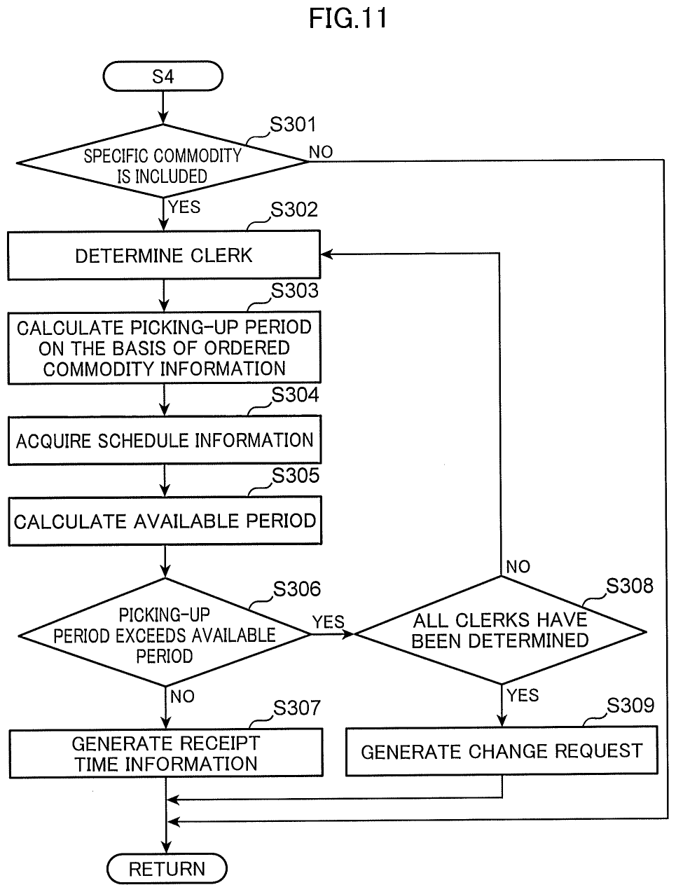

FIG. 11 is a flowchart showing details of the determination in step S4 in FIG. 3 in the second embodiment.

### Step S301

The determination part 122 determines whether an ordered commodity indicated by ordered commodity information includes a specific commodity. The process proceeds to step S302 when the ordered commodity includes a specific commodity (YES in step S301), and the process returns to the main routine when the ordered commodity includes no specific commodity (NO in step S301). For instance, the determination part 122 determines whether the ordered commodity includes a specific commodity with reference to a commodity database 134.

### Step S302

The determination part 122 determines a clerk to be a candidate. For instance, the determination part 122 may determine one clerk from a clerk list having registration of a plurality of clerks in written order.

### Step S303

This step is the same as step S101 in FIG. 5.

### Step S304

An acquisition part 121 acquires schedule information associated with a clerk ID of the determined clerk from the schedule information database 133.

### Step S305

The determination part 122 calculates a total value of scheduled picking-up periods for the determined clerk from the schedule information, and calculates an available period by subtracting the total value from the desired timeframe.

Referring to FIG. 10, the schedule information database 133 stores three pieces of schedule information as the schedule information about the clerk determined in step S302 and having the clerk ID “001” in the desired timeframe “14:00 to 16:00” for the new order T1. Here, the scheduled picking-up periods in the three pieces of schedule information respectively indicate ten minutes, twenty minutes, and forty minutes. The determination part 122 calculates the total value of the scheduled picking-up periods in the desired timeframe “14:00 to 16:00” as “70 minutes” for the clerk. The desired timeframe “14:00 to 16:00” has 120 minutes, and thus, the determination part 122 calculates a difference of “50 minutes” obtained by subtracting “70 minutes” from 120 minutes as an available period.

### Step S306

The determination part 122 determines whether a picking-up period required for the new order T1 exceeds the available period. The process proceeds to step S308 when the picking-up period exceeds the available period (YES in step S306), and the process proceeds to step S307 when the picking-up period does not exceed the available period (NO in step S306).

In the example in FIG. 10, the available period for the clerk in the desired timeframe “14:00 to 16:00” indicates “50 minutes”, and the picking-up period required for the new order T1 indicates “10 minutes”. In this case, the picking-up period of “10 minutes” does not exceed the available period of “50 minutes”, and thus, the clerk can perform a picking-up operation in the available period which falls within the desired timeframe. Therefore, the determination part 122 determines “NO” in step S306. By contrast, when the picking-up period exceeds the available period, it is determined to be “YES” in step S306.

### Step S307

This step is the same as step S103 in FIG. 5.

### Step S308

The determination part 122 determines whether all the clerks have been already determined. The process returns to step S302 when not all the clerks have been determined yet (NO in step S308), and the determination part 122 determines another clerk from the clerk list. Then, step S303 and the subsequent steps are executed, and it is determined whether another clerk can perform the picking-up operation in the desired timeframe. When all the clerks have been already determined (YES in step S308), the process proceeds to step S309.

### Step S309

This step is the same as step S104 in FIG. 5.

Conclusively, in the second embodiment, an available period for a clerk is calculated by subtracting a total value of scheduled picking-up periods from a desired timeframe, and an ordered commodity is determined to be receivable at a desired time or in a desired timeframe when a picking-up period required for a new order does not exceed the available period, and thus, the embodiment enables accurate determination in consideration of the scheduled picking-up period.

### Third Embodiment

A third embodiment is aimed at deciding a receipt time or a receipt timeframe in further consideration of a crowdedness timeframe in the second embodiment. In the embodiment, constituent elements which are the same as those in the first and second embodiments are given the same reference numerals and signs, and thus, description therefor will be omitted. Further, an overall configuration will be described with reference to FIG. 1 in this embodiment.

Referring to FIG. 1, a determination part 122 determines one clerk to be a candidate for picking up an ordered commodity among a plurality of clerks of a store.

An acquisition part 121 acquires schedule information associated with a clerk ID of the clerk determined by the determination part 122. The acquisition part 121 further acquires crowdedness timeframe information. The crowdedness timeframe information is the same as the crowdedness timeframe information described with reference to FIG. 9.

The determination part 122 calculates an available period for the clerk by subtracting a crowdedness timeframe and a scheduled picking-up period from a desired timeframe. The determination part 122 determines whether a picking-up period required for a new order exceeds the available period. The determination part 122 determines that the ordered commodity is receivable at a desired time or in a desired timeframe when the picking-up period required for the new order does not exceed the available period.

The determination part 122 calculates an available period for another clerk when the picking-up period exceeds the available period, and determines whether the picking-up period exceeds the available period for another clerk.

An output part 124 outputs a change request for a change of the desired time or the desired timeframe to a user terminal 2 by using a communication part 11 when the picking-up period exceeds the available period for another clerk.

The acquisition part 121 may execute the acquisition, and the determination part 122 may execute the calculation and determination when the ordered commodity includes a specific commodity as described above.

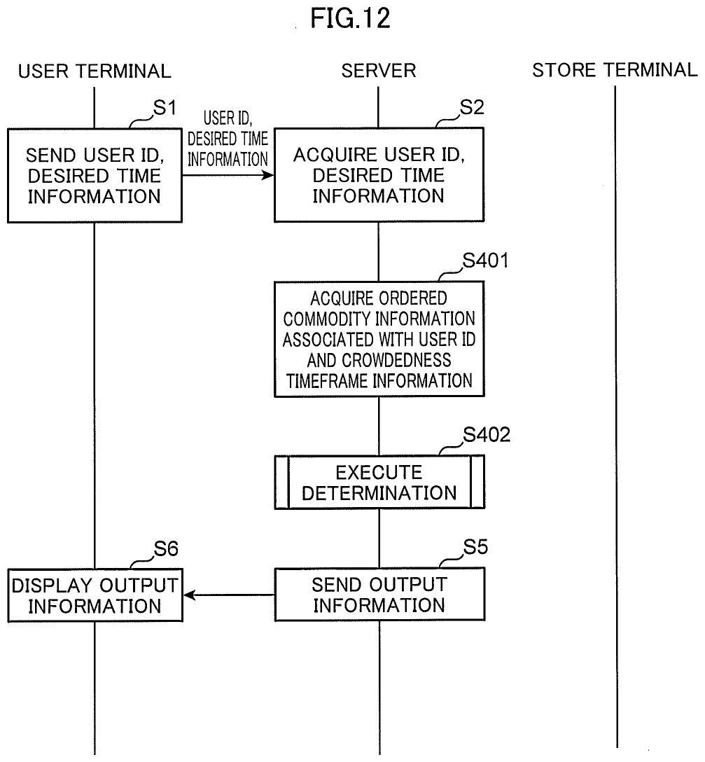

FIG. 12 is a flowchart showing a first example of a process by an information processing system 100 in the first embodiment.

In FIG. 12, steps which are the same as those in FIG. 3 are given the same reference numerals and signs, and thus, description therefor will be omitted.

### Step S401

The acquisition part 121 of a server 1 acquires, from an ordered commodity database 131, ordered commodity information associated with a user ID acquired in step S2, and acquires crowdedness timeframe information from a memory 13.

### Step S402

The server 1 executes, on the basis of ordered commodity information and the crowdedness timeframe information acquired in step S401 and desired time information acquired in step S2, determination as to whether the ordered commodity is receivable by the user in a desired timeframe indicated by the desired time information. The determination will be described in detail later.

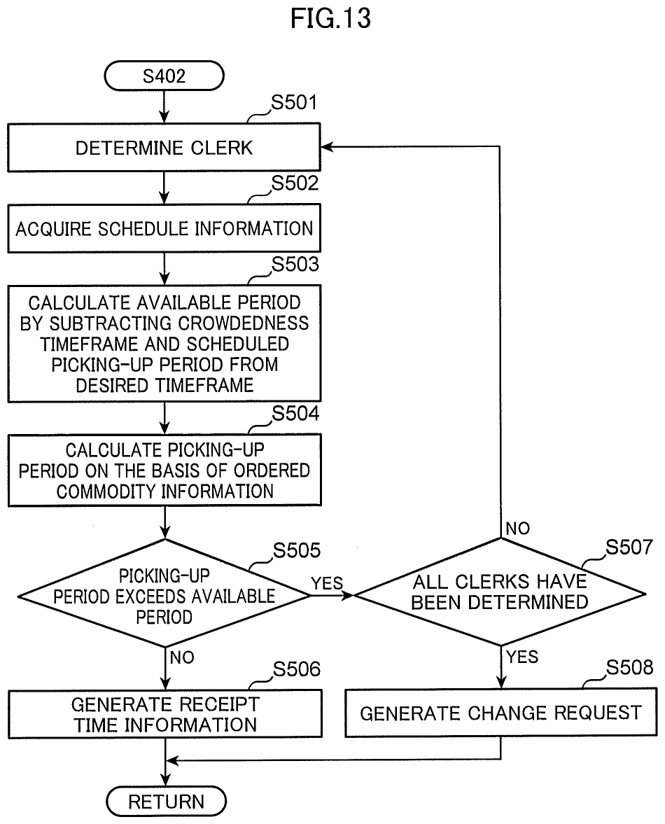

FIG. 13 is a flowchart showing details of the determination in step S402 in FIG. 12.

### Step S501

This step is the same as step S302 in FIG. 11.

### Step S502

This step is the same as step S304 in FIG. 11.

### Step S503

The determination part 122 calculates a total value of scheduled picking-up periods for the determined clerk from the schedule information, and calculates an available period by subtracting the total value and a crowdedness timeframe from the desired timeframe.

FIG. 14 is a view showing an example of a data configuration of a schedule information database 133A in the third embodiment. The schedule information database 133A additionally includes a crowdedness timeframe field in comparison with the schedule information database 133. First, the determination part 122 calculates a difference timeframe by subtracting a crowdedness timeframe “17:00 to 17:30” registered in the schedule information database 133A from a desired timeframe “17:00 to 19:00” for a new order T1. Here, the difference timeframe “17:30 to 19:00” is calculated by subtracting the crowdedness timeframe “17:00 to 17:30” from the desired timeframe “17:00 to 19:00”.

Subsequently, the determination part 122 calculates a total value of scheduled picking-up periods for the clerk having the clerk ID “001” and determined in step S501 in the desired timeframe “17:00 to 19:00” for the new order T1. Here, the schedule information database 133A has registration of three pieces of schedule information as the schedule information about the clerk in the desired timeframe “17:00 to 19:00”. Scheduled picking-up periods in the three pieces of schedule information respectively indicate ten minutes, ten minutes, and twenty minutes. The determination part 122 calculates the total value of the scheduled picking-up periods as “40 minutes”.

Next, the determination part 122 calculates, as an available period, a difference of “50 minutes” by subtracting the total value of “40 minutes” of the scheduled picking-up periods from a difference period of “90 minutes” indicated by the difference timeframe “17:30 to 19:00”.

### Step S504

This step is the same as step S101 in FIG. 5.

### Step S5

The determination part 122 determines whether a picking-up period calculated in step S504 exceeds the available period calculated in step S503. The process proceeds to step S506 when the picking-up period does not exceed the available period (NO in step S505), and the process proceeds to step S507 when the picking-up period exceeds the available period (NO in step S505).

In the example in FIG. 10, the available period for the clerk in the desired timeframe “17:00 to 19:00” indicates “50 minutes”, and the picking-up required period for the new order indicates “10 minutes”. In this example, the picking-up period of “10 minutes” does not exceed the available period of “50 minutes”, and thus, the clerk can perform a picking-up operation in the available period which falls within the desired timeframe. The determination part 122 hence determines “NO” in step S505. By contrast, when the picking-up period exceeds the available period, it is determined to be “YES” in step S505, and the process proceeds to step S507 to determine whether another clerk can perform a picking-up operation in the desired timeframe.

### Step S506

This step is the same as step S103 in FIG. 5.

### Step S507

This step is the same as step S308 in FIG. 11.

### S508

This step is the same as step S104 in FIG. 5.

Conclusively, in the third embodiment, an available period for a clerk is calculated by subtracting a crowdedness timeframe and a scheduled picking-up period from a desired timeframe, and an ordered commodity is determined to be receivable at a desired time or in a desired timeframe when the picking-up period does not exceed the available period. Thus, a receipt time or a receipt timeframe at earliest from a current time is determinable from the desired timeframe except the crowdedness timeframe.

### Fourth Embodiment

A fourth embodiment is aimed at estimating an arrival time of a user to a store.

In the embodiment, constituent elements which are the same as those in the first to third embodiments are given the same reference numerals and signs, and thus, description therefor will be omitted. Further, an overall configuration will be described with reference to FIG. 1 in this embodiment.

Referring to FIG. 1, an acquisition part 121 acquires location information about a user terminal 2 and traffic information about a periphery of the store. Examples of the traffic information include vehicle information and communication system (VICS: registered trademark) information provided from a traffic information providing system.

A determination part 122 estimates an arrival time of the user on the basis of the traffic information when the user terminal 2 is located in the periphery of the store a predetermined period before a receipt time or a receipt timeframe decided by a decision part 123. The term “predetermined period before the desired timeframe” means, for example, a predetermined period before a finish time of the desired timeframe. The predetermined time period takes an appropriate value, such as five minutes, ten minutes, and twenty minutes.

An output part 124 sends the arrival time to the store terminal 3 by using a communication part 11.

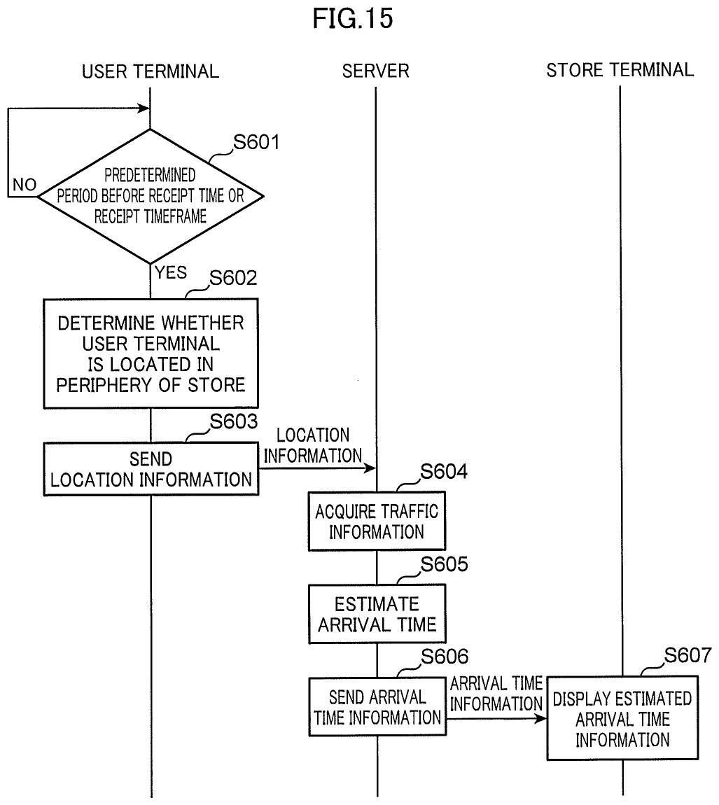

FIG. 15 is a flowchart showing an example of a process by an information processing system 100 in a case where a user arrives at or by a receipt time, or within a receipt timeframe in the fourth embodiment.

### Step S601

The user terminal 2 determines whether a current time is a predetermined period before a receipt time or a receipt timeframe. The process proceeds to step S602 when the current time is the predetermined period before the receipt time or the receipt timeframe (YES in step S601), and the process stays on standby in step S601 when the current time is not the predetermined period before the receipt time or the receipt timeframe (NO in step S601).

### Step S602

The user terminal 2 determines whether a location of the user terminal 2 indicated by location information acquired by a GPS sensor 25 is in the periphery of the store. Here, the user terminal 2 is located in the periphery of the store, and thus, the process proceeds to step S603. In this case, the user is highly likely to arrive at the store by or at the receipt time, or within the receipt timeframe.

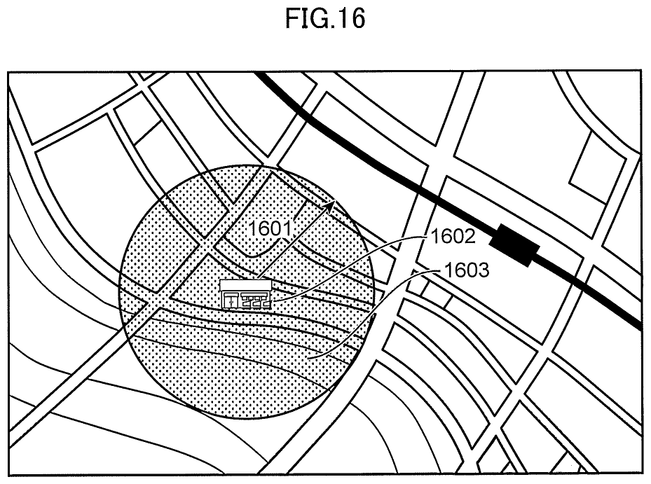

FIG. 16 is an illustration of a periphery of a store 1602. As shown in FIG. 16, examples of the periphery of the store 1602 include an area 1603 which is within a predetermined distance 1601 from the store 1602 serving as the center of the area. For instance, the predetermined distance 1601 may take an appropriate value, such as 1 km, 3 km, 5 km, and 10 km. The predetermined distance 1601 is appropriately settable. For instance, the predetermined distance 1601 may be set to an appropriate value in consideration of a locality to which the store 1602 belongs. The distance may be set to an appropriate value in consideration of a crowded state of the store 1602 and a traffic condition of the periphery. For example, the predetermined distance 1601 may be set to a smaller value for a timeframe during which the store 1602 is crowded or a timeframe during which the periphery is in traffic congestion than a value for another timeframe.

The predetermined distance 1601 may be changed in accordance with a content of an ordered commodity. For instance, the predetermined distance 1601 for an ordered commodity having an attribute of requiring a large burden on a clerk for a picking-up operation may be set to a longer distance than a predetermined distance for an ordered commodity which does not have the attribute. Examples of the commodity requiring a large burden on the clerk include a large commodity, such as a piece of furniture.

### Step S603

The user terminal 2 sends location information acquired by the GPS sensor 25 to a server 1.

### Step S604

The acquisition part 121 of the server 1 acquires traffic information about the periphery of the store 1602.

### Step S605

The determination part 122 of the server 1 estimates an arrival time of the user at the store 1602 by using the acquired traffic information and location information sent from the user terminal 2. For instance, the determination part 122 may estimate an arrival time of the user at the store 1602 by inputting the location information about the user terminal 2, location information about the store, a current time, and traffic information into a route retrieval system. The route retrieval system may be included in the server 1, or may be a system provided on a route retrieval service on the Internet.

### Step S606

An output part 124 of the server 1 sends arrival time information indicating the estimated arrival time to the store terminal 3.

### Step S607

The store terminal 3 displays the arrival time information on a display 33.

Consequently, arrival time information indicating an arrival time of the user estimated on the basis of the traffic information is displayed on the store terminal 3 when the user is located in the periphery of the store a predetermined before the receipt time or the receipt timeframe. This allows the store to prepare a picking-up operation of picking up an ordered commodity to meet the arrival time.

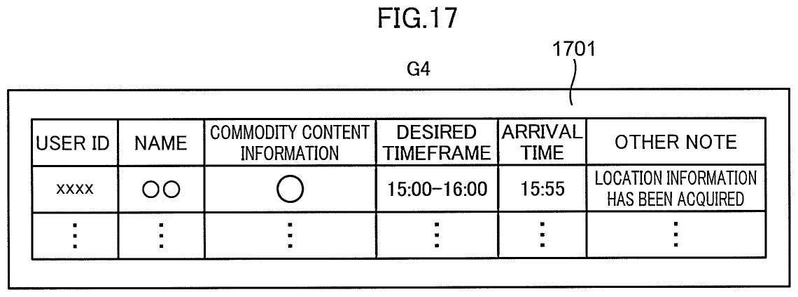

FIG. 17 is an illustration of an example of a display screen image G4 displayed on the store terminal 3. The display screen image G4 includes a delivery table 1701 showing a list of information about users for whom deliveries have been scheduled respectively at the store. In the delivery table 1701, one row is associated with one order. The delivery table 1701 includes a user ID field, a name field, a commodity content information field, a desired timeframe field, an arrival time field, and an other note field.

A user ID is an identifier of the user. A name is the name of the user. Commodity content information shows a content of an ordered commodity. Examples of the content of the ordered commodity include a commodity name of the ordered commodity and the number of ordered commodities. The commodity content information field may show a predefined pickup difficulty level in association with a content of an ordered commodity. The difficulty level is shown in a stepwise manner, e.g., “3” for a frozen food” and “5” for a large commodity. In this case, the ordered commodity information field shows, for example, a message indicating existence of commodities having the difficulty levels “3” and “5” respectively.

A desired timeframe is input by the user. An arrival time is estimated in the process in FIG. 15.

The other note field shows supplemental information. This example displays a message showing a success in acquisition of location information from the user terminal 2 through the process in FIG. 15.

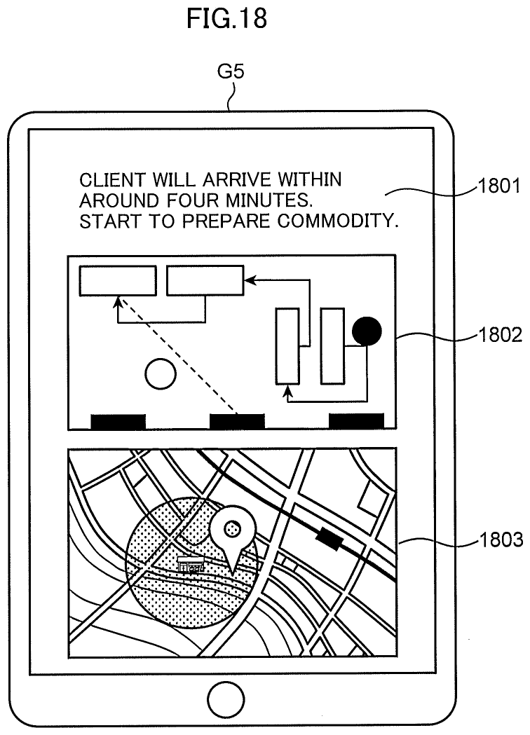

When a clerk inputs a manipulation of touching a certain row in the delivery table 1701, the store terminal 3 displays a display screen image showing details of arrival time information about the selected order. FIG. 18 is an illustration of an example of a display screen image G5 showing details of arrival time information about a certain order selected by a clerk.

The display screen image G5 includes a message section 1801, a pickup route display section 1802, and a map display section 1803.

The message section 1801 shows a message for telling a clerk that the user will arrive at the store soon (within four minutes) and encouraging the clerk to prepare a picking-up operation for an ordered commodity.

The pickup route display section 1802 shows a pickup route for the clerk to pick up the commodity in the store. For example, the pickup route display section 1802 shows an image in which a pickup route is superimposed and displayed on a map image of the store as shown in FIG. 6.

The map display section 1803 shows a current location of the user terminal 2. The map display section 1803 shows an image in which the current location of the user terminal 2 is superimposed and displayed on a map image of the periphery of the store.

Displaying of the display screen image G5 on the store terminal 3 allows the clerk to smoothly pick up the ordered commodity and deliver the ordered commodity without delay.

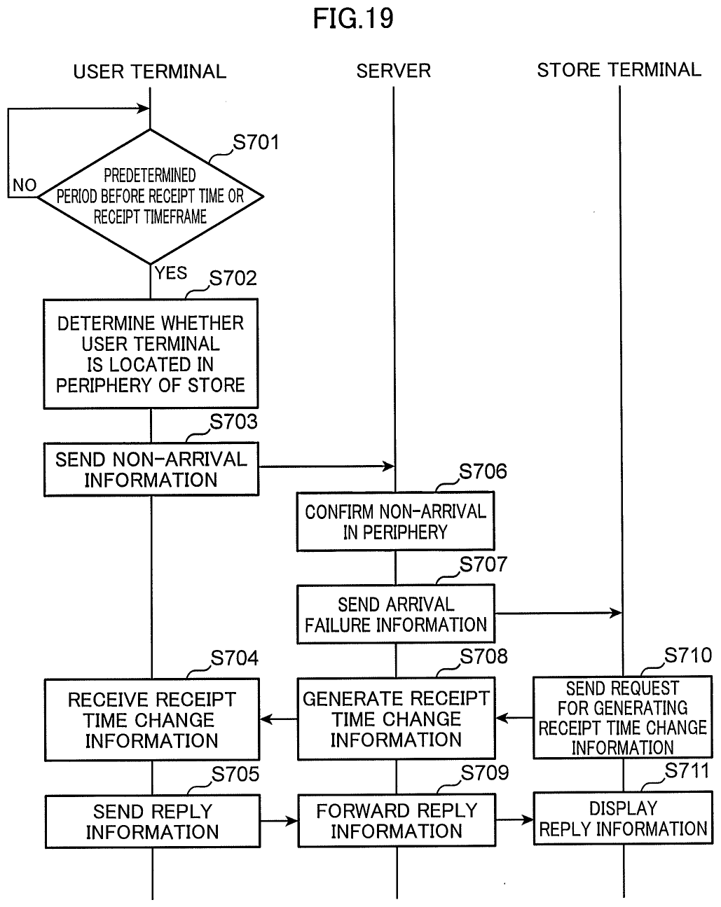

FIG. 19 is a flowchart showing an example of a process by the information processing system 100 in a case where a user will fail to arrive by or at a receipt time, or within a receipt timeframe in the fourth embodiment.

### Step S701

This step is the same as step S601 in FIG. 15.

### Step S702

The user terminal 2 determines whether a location of the user terminal 2 indicated by location information acquired by the GPS sensor 25 is in the periphery of the store. Here, the user terminal 2 is located outside the periphery of the store. The user terminal 2 hence determines that the user terminal 2 is not located in the periphery of the store and leads the process to step S703.

### Step S703

The user terminal 2 sends non-arrival information indicating that the user terminal 2 is not located in the periphery of the store to the server 1.

### Step S706

The determination part 122 of the server 1 confirms that the user terminal 2 is not located in the periphery of the store owing to the acquisition of the non-arrival information.

### Step S707

The output part 124 of the server 1 sends, to the store terminal 3, arrival failure information indicating that the user will fail to arrive by or at the store at an arrival time, or within an arrival timeframe.

### Step S710

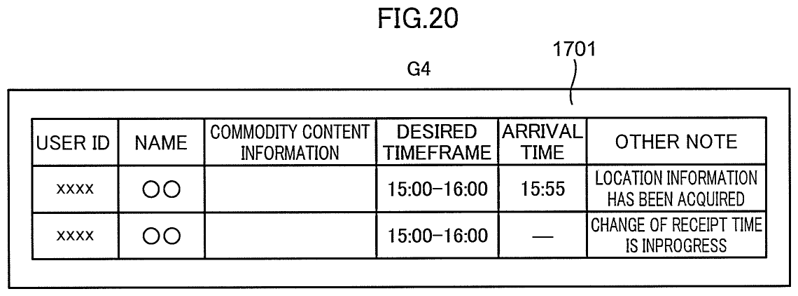

The store terminal 3 sends a request for generating receipt time change information to the server 1. FIG. 20 is an illustration of an example of a display screen image G4 displayed on the store terminal 3 on receipt of receipt time change information. The display screen image G4 includes a delivery table 1701 similar to that in FIG. 17. In the delivery table 1701, an order in the second row shows that receipt time change information has been sent. Thus, the other note field in the second row shows a message saying that a change of the receipt time is in progress.

### Step S708

The determination part 122 of the server 1 generates receipt time change information. The output part 124 of the server 1 sends the generated receipt time change information to the user terminal 2.

The receipt time change information is information for allowing the user to set a desired timeframe for receiving the ordered commodity again. The receipt time change information includes a plurality of change timeframes. The user selects one desired change timeframe from the change timeframes.

For instance, the server 1 may calculate an available period by using the way described in the second embodiment and generate the receipt time change information on the basis of the calculated available period. More details will be described below. The determination part 122 determines a clerk. An acquisition part 121 acquires schedule information associated with a clerk ID of the determined clerk from a schedule information database 133. The determination part 122 calculates a total value of scheduled picking-up periods from the acquired schedule information. The determination part 122 calculates an available period for the clerk by subtracting the scheduled picking-up periods from a desired timeframe. The determination part 122 executes the acquisition and calculation for each of the clerks to calculate an available period for each clerk. The determination part 122 calculates a disjunction of available periods for respective clerks as an available period of the store. The determination part 122 determines a plurality of change timeframes by dividing the available period of the store by a predetermined period (e.g., five minutes, ten minutes, twenty minutes, thirty minutes, or other period) to generate receipt time change information including the change timeframes.

For the calculation of the receipt time change information, the server 1 may calculate an available period by using the way described in the third embodiment. In this case, the determination part 122 may calculate, as the available period, a period by subtracting a total value of scheduled picking-up periods and a crowdedness timeframe from a desired timeframe.

### Step S704

The user terminal 2 receives the receipt time change information and displays the receipt time change information on a display 23.

### Step S705

The user terminal 2 receives, from the user, a manipulation of selecting one change timeframe from the change timeframes included in the receipt time change information, generates reply information indicating the one change timeframe, and sends the generated reply information to the server 1.

### Step S709

The output part 124 of the server 1 forwards the reply information to the store terminal 3. In this case, the server 1 determines a clerk to perform a picking-up operation in the change timeframe indicated by the response information and updates the schedule information database 133 on the basis of a result of the determination. In this case, the server 1 may determine a clerk having an available period in the change timeframe indicated by the response information as a clerk to perform the picking-up operation.

### Step S711

The store terminal 3 displays the reply information on the display 33. This allows the clerk to confirm another desired timeframe having been set.

It is seen from comparison between step S603 in FIG. 15 and step S703 in FIG. 19 that the location information about the user terminal 2 is sent to the server 1 only when it is detected that the user terminal 2 is located in the periphery of the store in the embodiment. This enables prevention of a leakage of personal information about a user.

When the user judges that the user will fail to arrive by or at the receipt time, or within the receipt timeframe, the user terminal 2 may send a change request for requesting a change of the receipt time or the receipt timeframe to the server 1 in accordance with an instruction from the user.

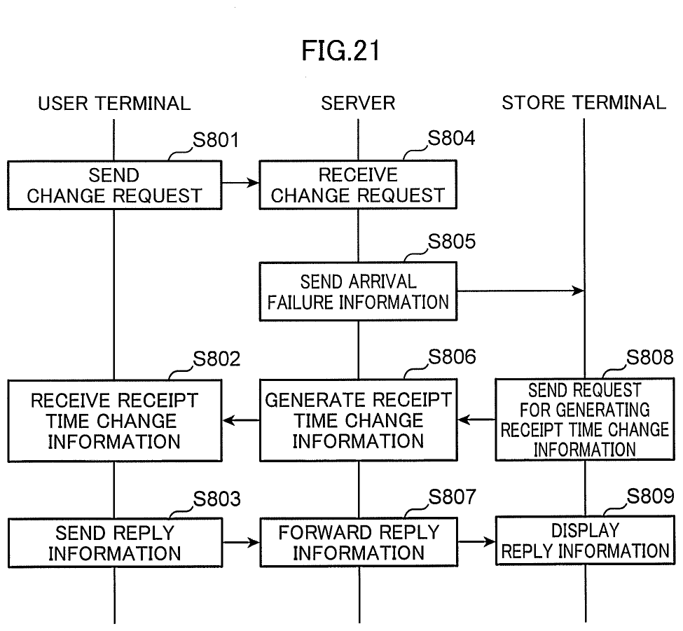

FIG. 21 is a flowchart showing an example of sending a change request for requesting a change of a receipt time or a receipt timeframe by the user terminal 2 in the fourth embodiment.

### Step S801

The user terminal 2 receives a manipulation of sending a change request from a user and sends the change request to the server 1.

### Step S804

The server 1 receives the change request.

Hereinafter, the same steps as those in FIG. 19 are executed. Specifically, steps S802, S803, S805, S806, S807, S808, and S809 are respectively the same as step S704, S705, S707, S708, S709, S710, and S711 in FIG. 19.

In this manner, when the user judges that the user will fail to arrive by or at the receipt time, or within the receipt timeframe, the user can notify the store of the possible failure in advance. This is convenient for both the user and the store.

This disclosure can adopt modifications described below.

(1) Although the first to fourth embodiments are intended for a user who comes to a store to receive an ordered commodity by a vehicle, the present disclosure is not limited thereto. For instance, the disclosure is applicable to a user who walks to the store to receive an ordered commodity. Further, the vehicle may include an automobile, a motorbike, a bicycle, and a scooter.

(2) Concerning the display screen image G1 shown in FIG. 2, the user terminal 2 may make a user input a desired time at which the user desires to receive an ordered commodity. In this case, the user terminal 2 may display an input screen image for inputting the desired time on the display 23.

(3) Although the available period of “50 minutes” is continuous in the example in FIG. 10, the available period may not be continuous depending on the content of the schedule information. In this case, in step S306 in FIG. 11, the determination part 122 may divide the available period into a plurality of available period divisions, and compare each of the available period divisions with a picking-up period. The determination part 122 may determine “NO” in step S306 when the picking-up period does not exceed at least one available period division, and may determine “YES” in step S306 when the picking-up period exceeds all the available period divisions. This is applicable to step S505 in FIG. 13.

This disclosure is useful for an efficient delivery of a commodity in a large-scale store.

1. An information processing method for providing information about delivery of commodities at a store, the information processing method comprising:
by a computer,
acquiring a user ID, desired time information associated with the user ID and indicating a desired time or a desired timeframe for receiving a commodity, and ordered commodity information associated with the user ID;
determining, on the basis of the desired time information and the ordered commodity information, whether an ordered commodity indicated by the ordered commodity information is receivable at the desired time or in the desired timeframe;
deciding a receipt time or a receipt timeframe for the ordered commodity when the ordered commodity is determined to be receivable at the desired time or in the desired timeframe; and
outputting receipt time information indicating the receipt time or the receipt timeframe.

2. The information processing method according to claim 1, wherein,
in the outputting, when the ordered commodity is determined to be unreceivable at the desired time or in the desired timeframe, a change request for a change of the desired time or the desired timeframe is output.

3. The information processing method according to claim 1, further comprising acquiring a current time, wherein,
in the determining,
a picking-up period required to pick up the ordered commodity is calculated on the basis of the ordered commodity information, and
it is determined on the basis of the current time and the picking-up period whether the ordered commodity is receivable at the desired time or in the desired timeframe.

4. The information processing method according to claim 3, further comprising acquiring crowdedness timeframe information indicating a crowdedness timeframe of the store, wherein,
in the determining,
it is determined whether a pickup time obtained by adding the picking-up period with respect to the current time falls within the crowdedness timeframe, and,
when the pickup time is determined not to fall within the crowdedness timeframe, it is determined whether the ordered commodity is receivable at the desired time or in the desired timeframe on the basis of determination as to whether the pickup time is earlier than the desired time.

5. The information processing method according to claim 3, wherein,
in the calculating of the picking-up period, the picking-up period is calculated on the basis of the number of ordered commodities indicated by the ordered commodity information.

6. The information processing method according to claim 3, further comprising acquiring commodity location information indicating respective locations of the commodities at the store, wherein
in the calculating of the picking-up period,
a location of the ordered commodity is specified on the basis of the commodity location information and the ordered commodity information, and
the picking-up period is calculated on the basis of the location of the ordered commodity.

7. The information processing method according to claim 1, wherein,
in the outputting, display information about a location of the ordered commodity and a route for picking up the ordered commodity is output.

8. The information processing method according to claim 3, further comprising:
determining a clerk to pick up the ordered commodity;
acquiring schedule information associated with a clerk ID of the clerk and indicating a scheduled picking-up period being a picking-up period having been scheduled for the clerk;
calculating an available period for the clerk by subtracting the scheduled picking-up period from the desired timeframe;
determining whether the picking-up period exceeds the available period; and
determining that the ordered commodity is receivable at the desired time or in the desired timeframe when the picking-up period does not exceed the available period.

9. The information processing method according to claim 8, further comprising determining whether the ordered commodity indicated by the ordered commodity information includes a specific commodity, wherein
the available period is calculated when the ordered commodity includes the specific commodity.

10. The information processing method according to claim 3, further comprising:
acquiring crowdedness timeframe information indicating a crowdedness timeframe of the store;
determining a clerk to pick up the ordered commodity;
acquiring a scheduled picking-up period being a picking-up period which is associated with a clerk ID of the clerk and has been scheduled;
calculating an available period for the clerk by subtracting the crowdedness timeframe and the scheduled picking-up period from the desired timeframe;
determining whether the picking-up period exceeds the available period; and
determining that the ordered commodity is receivable at the desired time or in the desired timeframe when the picking-up period does not exceed the available period.

11. The information processing method according to claim 8, further comprising calculating an available period for another clerk when the picking-up period exceeds the available period, and determining whether the picking-up period exceeds the available period for the another clerk.

12. The information processing method according to claim 11, further comprising outputting a change request for a change of the desired time or the desired timeframe when the picking-up period exceeds the available period for the another clerk.

13. The information processing method according to claim 1, further comprising:
acquiring location information about a user terminal carried by the user and traffic information about a traffic in a periphery of the store;
estimating an arrival time of the user on the basis of the traffic information when the user terminal is located in the periphery of the store a predetermined period before the receipt time or the receipt timeframe; and
outputting the arrival time.

14. The information processing method according to claim 13, further comprising:
acquiring schedule information associated with a clerk ID of a clerk of the store and indicating a scheduled picking-up period being a picking-up period having been scheduled for the clerk;
calculating an available period for the clerk by subtracting the scheduled picking-up period from the desired timeframe;
generating receipt time change information including an available delivery time for the ordered commodity on the basis of the available period when the user terminal is not located in the periphery of the store; and
outputting the receipt time change information.

15. An information processing device that provides information about delivery of commodities at a store, the information processing device comprising:
an acquisition part that acquires a user ID, desired time information associated with the user ID and indicating a desired time or a desired timeframe for receiving a commodity, and ordered commodity information associated with the user ID;
a determination part that determines, on the basis of the desired time information and the ordered commodity information, whether an ordered commodity indicated by the ordered commodity information is receivable at the desired time or in the desired timeframe;
a decision part that decides a receipt time or a receipt timeframe for the ordered commodity when the ordered commodity is determined to be receivable at the desired time or in the desired time; and
an output part that outputs receipt time information indicating the receipt time or the receipt timeframe.

16. A non-transitory computer readable recording medium storing an information processing program for providing information about delivery of commodities at a store, the information processing program comprising:
causing a computer to execute:
acquiring a user ID, desired time information associated with the user ID and indicating a desired time or a desired timeframe for receiving a commodity, and ordered commodity information associated with the user ID;
determining, on the basis of the desired time information and the ordered commodity information, whether an ordered commodity indicated by the ordered commodity information is receivable at the desired time or in the desired timeframe;
deciding a receipt time or a receipt timeframe for the ordered commodity when the ordered commodity is determined to be receivable at the desired time or in the desired timeframe; and
outputting receipt time information indicating the receipt time or the receipt timeframe.
